(19) United States
(12) Patent Application Publication
(10) Pub. No.: US 2026/0054101 A1
(43) Pub. Date: Feb. 26, 2026

(54) MULTI-PURPOSE SURVIVAL TOOL

(71) Applicant: Robert E. Bina, Quincy, MA (US)

(72) Inventor: Robert E. Bina, Quincy, MA (US)

(21) Appl. No.: 19/247,847

(22) Filed: Jun. 24, 2025

Related U.S. Application Data
(63) Continuation-in-part of application No. 17/888,780, filed on Aug. 16, 2022, now abandoned.
Application No. 17/888,780 is a continuation of application No. 17/147,624, filed on Jan. 13, 2021, now Pat. No. 11,413,478.
(60) Provisional application No. 62/961,366, filed on Jan. 15, 2020.
(60) Provisional application No. 63/751,817, filed on Jan. 30, 2025.

(51) Int. Cl. A62B 3/00; F21V 33/00; F41H 9/10

(52) U.S. Cl. CPC A62B 3/005; F21V 33/0064; F41H 9/10

(57) ABSTRACT

A multi-purpose tool, the tool comprising: a front leg having an upper portion and a lower portion; a rear leg having an upper portion and a lower portion; a top portion connecting the upper portion of the front leg to the upper portion of the rear leg; and a bottom portion connecting the lower portion of the front leg to the lower portion of the rear leg; an illumination unit disposed in the top portion of the tool; and a pepper spray unit disposed in the front leg of the tool; wherein the front leg, the rear leg, the top portion and the bottom portion form a central cavity that is sized to receive fingers of a user's hand, with the heel of the hand resting against the rear leg and the thumb of the hand free to manipulate (i) an illumination actuation element for operating the illumination unit, and (ii) a pepper spray actuation element for operating the pepper spray unit.

### REFERENCE TO PENDING PRIOR PATENT APPLICATIONS

This patent application:
(i) is a continuation-in-part of pending prior U.S. patent application Ser. No. 17/888,780, filed Aug. 16, 2022 by Robert E. Bina et al. for MULTI-PURPOSE ILLUMINATION, SELF-DEFENSE AND GLASS-BREAKING TOOL (Attorney's Docket No. SCHUERCHBINA-1 CON), which patent application in turn:
(a) is a continuation of prior U.S. patent application Ser. No. 17/147,624, filed Jan. 13, 2021 by Robert E. Bina et al. for MULTI-PURPOSE ILLUMINATION, SELF-DEFENSE AND GLASS-BREAKING TOOL (Attorney's Docket No. SCHUERCHBINA-1), which patent application in turn:
   (1) claims benefit of prior U.S. Provisional Patent Application Ser. No. 62/961,366, filed Jan. 15, 2020 by Robert E. Bina et al. for MULTI-PURPOSE SELF-DEFENSE AND SAFETY TOOL (Attorney's Docket No. SCHUERCHBINA-1 PROV); and
(ii) claims benefit of pending prior U.S. Provisional Patent Application Ser. No. 63/751,817, filed Jan. 30, 2025 by Robert E. Bina for MULTI-PURPOSE SURVIVAL TOOL (Attorney's Docket No. BINA-4 PROV).

The four (4) above-identified patent applications are hereby incorporated herein by reference.

### FIELD OF THE INVENTION

This invention relates to multi-purpose tools in general, and more particularly to multi-purpose tools for self-defense and survival.

### BACKGROUND OF THE INVENTION

In many circumstances a person may need illumination, such as at night, or when in a dark building, etc. In this case, a flashlight or the like may be useful.

And in many circumstances a person may need self-defense capabilities, such as to fend off an assailant. In this case, a pepper spray unit may be desirable.

And in certain circumstances, a person may need glass-breaking or seat belt-cutting capabilities, such as when the person needs to quickly exit a motor vehicle when exit through the vehicle doors is not possible. In this case, a glass-breaking tool may be critical for breaking glass and/or a seat belt-cutting tool may be critical for cutting a seat belt.

And in some circumstances, a person may need some combination of one or more of illumination, self-defense capabilities and/or glass-breaking capabilities and/or seat belt-cutting capabilities. In such a situation, the need to locate and handle two or more separate, single-purpose devices can be a significant hindrance to rapidly achieving the desired illumination, self-defense, glass-breaking capability and seat belt-cutting. This is especially true in emergency situations where time is of the essence, and other situations where fumbling with multiple, single-purpose devices can hinder rapid access to illumination, self-defense, glass-breaking and seat belt-cutting capability.

Thus there is a need for a novel multi-purpose survival tool which can provide, in a single device, illumination, self-defense capability, glass-breaking capability and/or seat belt-cutting capability.

### SUMMARY OF THE INVENTION

The present invention comprises the provision and use of a novel multi-purpose survival tool which can provide, in a single device, illumination, self-defense capability, glass-breaking capability and seat belt-cutting capability.

Significantly, the novel multi-purpose survival tool of the present invention is configured such that the user is able to wield and operate the multi-purpose survival tool with only one hand, without the need to actively grip the multi-purpose survival tool with their fingers, leaving their fingers free to grab keys, open a door, hold a firearm, etc.

In one form of the invention, there is provided a multi-purpose illumination, self-defense and glass-breaking tool, the tool comprising:
a tool body;
a handle projecting from the tool body;
a flashlight carried by the tool body;
a pepper spray unit carried by the tool body; and
a glass breaker carried by the handle.

In another form of the invention, there is provided a method for providing at least one of illumination, pepper spray dispensing and glass-breaking capability, the method comprising:
providing a multi-purpose illumination, self-defense and glass-breaking tool, the tool comprising:
   a tool body;
   a handle projecting from the tool body;
   a flashlight carried by the tool body;
   a pepper spray unit carried by the tool body; and
   a glass breaker carried by the handle;
engaging the handle of the tool with the fingers of a user; and
taking at least one of the following actions:
   (i) providing illumination via the flashlight;
   (ii) dispensing pepper spray from the pepper spray unit; and
   (iii) breaking glass by driving the glass breaker against glass.

In another form of the invention, there is provided a multi-purpose tool, the tool comprising:
a front leg having an upper portion and a lower portion;
a rear leg having an upper portion and a lower portion;
a top portion connecting the upper portion of the front leg to the upper portion of the rear leg; and
a bottom portion connecting the lower portion of the front leg to the lower portion of the rear leg;
an illumination unit disposed in the top portion of the tool; and
a pepper spray unit disposed in the front leg of the tool;
wherein the front leg, the rear leg, the top portion and the bottom portion form a central cavity that is sized to receive fingers of a user's hand, with the heel of the hand resting against the rear leg and the thumb of the hand free to manipulate (i) an illumination actuation element for operating the illumination unit, and (ii) a pepper spray actuation element for operating the pepper spray unit.

In another form of the invention, there is provided a method for providing at least one of illumination and pepper spray dispensing capability, the method comprising:
providing a multi-purpose tool, the tool comprising:
   a front leg having an upper portion and a lower portion;
   a rear leg having an upper portion and a lower portion;
   a top portion connecting the upper portion of the front leg to the upper portion of the rear leg; and
   a bottom portion connecting the lower portion of the front leg to the lower portion of the rear leg;
   an illumination unit disposed in the top portion of the tool; and
   a pepper spray unit disposed in the front leg of the tool;
   wherein the front leg, the rear leg, the top portion and the bottom portion form a central cavity that is sized to receive fingers of a user's hand, with the heel of the hand resting against the rear leg and the thumb of the hand free to manipulate (i) an illumination actuation element for operating the illumination unit, and (ii) a pepper spray actuation element for operating the pepper spray unit;
passing fingers of a hand of a user through the cavity of the tool; and
using the thumb of the hand of the user to perform at least one of the following actions:
   (i) providing illumination via the illumination unit; and
   (ii) dispensing pepper spray from the pepper spray unit.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like parts, and further wherein:

FIGS. 1-5 are schematic views showing a novel multi-purpose illumination, self-defense and glass-breaking tool formed in accordance with the present invention;

FIGS. 6-10 are schematic views showing another novel multi-purpose illumination, self-defense and glass-breaking tool formed in accordance with the present invention; and

FIGS. 11-41 are schematic views showing another novel multi-purpose survival tool formed in accordance with the present invention.

### DETAILED DESCRIPTION OF THE PREFERRED EMBODIMENTS

The present invention comprises the provision and use of a novel multi-purpose illumination, self-defense and glass-breaking tool.

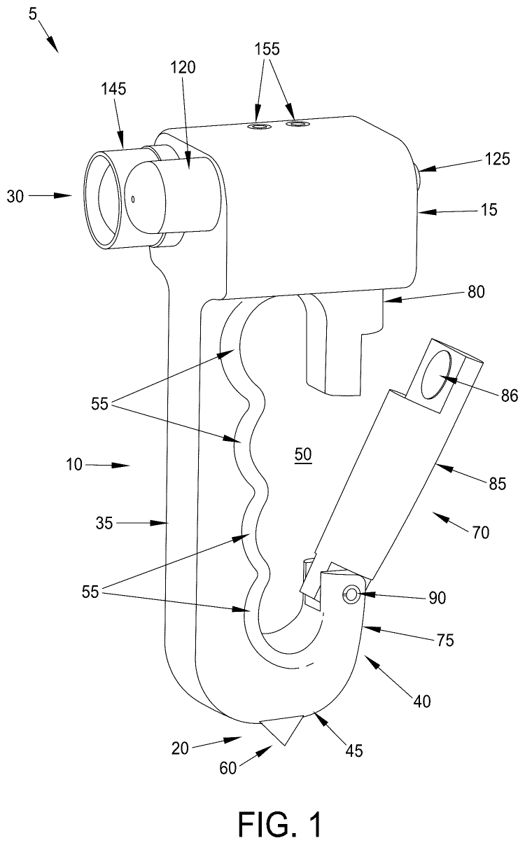

Looking first at FIGS. 1-5, in a first embodiment of the present invention, there is provided a multi-purpose illumination, self-defense and glass-breaking tool 5 generally comprising a handle 10 extending from a tool body 15, wherein handle 10 carries a glass breaker 20, and wherein tool body 15 carries a pepper spray unit 25 and a flashlight 30.

More particularly, handle 10 is formed with a “U” shape which projects from the bottom of tool body 15. The “U” shape of handle 10 is formed by a front leg 35 and a rear leg 40, both of which project downward from the bottom of tool body 15, and a closed bottom connector 45 which extends between the bottom portions of front leg 35 and rear leg 40. The “U” shape of handle 10 in turn creates an interior space 50 which is sized to receive the four fingers of a user's hand, with the heel of the hand resting against rear leg 40. In one form of the invention, interior space 50 is sized to closely receive the four fingers of a user's hand. In order to improve the fit and prevent slippage of the user's fingers within interior space 50, grooves 55 may be provided on the inward-facing surface of front leg 35 in order to closely contour-mate front leg 35 with the four fingers of the user's hand. Significantly, with such a construction, multi-purpose illumination, self-defense and glass-breaking tool 5 can be maintained on the user's hand solely by the fit of handle 10 around the user's fingers (i.e., the user does not need to actively grip rear leg 40 of handle 10 with the four fingers of his/her hand). It will be appreciated that, without the need for the user to actively grip rear leg 40 of handle 10 with the four fingers of his/her hand, the four fingers of the user's hand are free to grab keys, open a door, hold a gun, etc., while the user wields multi-purpose illumination, self-defense and glass-breaking tool 5.

On the bottom side of closed bottom connector 45, there is provided a glass breaker 20 for use in breaking glass, e.g., vehicle windows in the case of an emergency. Glass breaker 20 comprises a cone-shaped point 60 extending from a threaded body 65. Glass breaker 20 may comprise a ½-13×¾″ cone point set screw sold by McMaster Carr. Threaded body 65 is preferably completely received by closed bottom connector 45 of handle 10 such that only point 60 protrudes outward from closed bottom connector 45. Point 60 provides a small surface area onto which the force generated from a user swinging multi-purpose illumination, self-defense and glass-breaking tool 5 can be concentrated, thereby allowing the user to more readily break glass, e.g., a car window in the case of an emergency. To that end, glass breaker 20 is preferably made of a hard and strong material such as alloy steel, and handle 10 (and tool body 15) are preferably made of a durable material such as onyx nylon which can withstand the forces generated during the use of glass breaker 20 of multi-purpose illumination, self-defense and glass-breaking tool 5.

In one form of the invention, a latch 70 is provided on rear leg 40 of handle 10 so that handle 10 can act as a carabiner for clipping or hanging multi-purpose illumination, self-defense and glass-breaking tool 5 to another object (e.g., to a belt or to a loop provided on an article of clothing), or for clipping or hanging another object (e.g., a whistle on a short lanyard) to multi-purpose illumination, self-defense and glass-breaking tool 5. More specifically, rear leg 40 of handle 10 may comprise a bottom section 75 and a top section 80, with an arm 85 extending therebetween. One end of arm 85 is pivotally mounted to bottom section 75 of rear leg 40 by a spring pin 90 (e.g., a 3/16×7/8 spring pin sold by McMaster Carr) such that arm 85 is able to swing outward from top section 80, opening the “U” shape of handle 10 so that the interior space 50 of the handle can be accessed through latch 70 of rear leg 40, and then spring back into contact with top section 80 so as to restore the “U” shape of handle 10 (i.e., so that interior space 50 of the handle can no longer be accessed through latch 70 of rear leg 40). To help keep the “U” shape of handle 10 closed, a selective closure means 86 (e.g., NEO 35 (NdFeB) magnets sold by McMaster Carr) may be provided on top section 80 of rear leg 40 and the free end of arm 85.

Thus, where, for example, multi-purpose illumination, self-defense and glass-breaking tool 5 is to be clipped to the belt of a user, latch 70 is opened, handle 10 is moved so that the belt is passed through open latch 70, and then latch 70 is closed so as to securely clip multi-purpose illumination, self-defense and glass-breaking tool 5 to the belt of the user. When multi-purpose illumination, self-defense and glass-breaking tool 5 is thereafter to be used, latch 70 is opened, handle 10 is moved so that the belt is passed through open latch 70, latch 70 is closed so as to restore the normal “U” shape of handle 10, and then the fingers of the user are passed through interior space 50 so that multi-purpose illumination, self-defense and glass-breaking tool 5 is mounted to the fingers of the user. Furthermore, where, for example, multi-purpose illumination, self-defense and glass-breaking tool 5 is to have a whistle (on a short lanyard) clipped to handle 10, latch 70 is opened, the lanyard of the whistle is passed through open latch 70, and then latch 70 is closed so as to securely clip the lanyard of the whistle (and hence securely clip the whistle) to multi-purpose illumination, self-defense and glass-breaking tool 5. When the whistle is to be unclipped from multi-purpose illumination, self-defense and glass-breaking tool 5, latch 70 is opened, the lanyard of the whistle is passed through open latch 70, and latch 70 is closed, so as to restore the normal “U” shape of handle 10.

Looking next at tool body 15, tool body 15 comprises parallel, cylindrical cavities 95 and 100 sized to receive pepper spray unit 25 and flashlight 30, respectively. Cavities 95 and 100 (and therefore pepper spray unit 25 and flashlight 30) extend horizontally through tool body 15 from the front end of tool body 15 to the rear end of tool body 15. With pepper spray unit 25 and flashlight 30 in this orientation, the user is able to easily reach/operate the back ends of both pepper spray unit 25 and flashlight 30 with his/her thumb of the same hand which holds multi-purpose illumination, self-defense and glass-breaking tool 5. Hence, multi-purpose illumination, self-defense and glass-breaking tool 5 can be held and fully operated with one hand.

With respect to pepper spray unit 25, pepper spray unit 25 comprises a replaceable pepper spray canister (e.g., a pepper spray Spitfire Refill Unit sold by Sabre Red, or another pepper spray refill unit available from Sabre Red or another manufacturer) having a front end 105 from which pepper spray fluid is discharged, and a rear end 110 which the user can depress to initiate discharge of pepper spray fluid. Pepper spray unit 25 is loaded, rear end 110 first, into the front end of cavity 95 until pepper spray unit 25 reaches a narrowed opening 115 at the rear of cavity 95. Narrowed opening 115 has a smaller diameter than pepper spray unit 25, whereby to prevent pepper spray unit 25 from sliding out of the rear end of cavity 95. Pepper spray unit 25 is then secured within cavity 95 by screwing a threaded nozzle extender 120 onto the front end of cavity 95.

To initiate discharge of pepper spray fluid from pepper spray unit 25, rear end 110 of pepper spray unit 25 must be pressed toward the remainder of pepper spray unit 25, i.e., rear end 110 must be pushed forward. This is facilitated by a push button 125 extending through narrowed opening 115 of cavity 95. Pressing push button 125 forward against rear end 110 of pepper spray unit 25 causes pepper spray fluid to be discharged out the front of pepper spray unit 25. However, a safety stop 130 is preferably also provided to prevent the user from accidentally discharging pepper spray fluid with an errant press of push button 125. More particularly, safety stop 130 is slidably held within a vertical slot 135 on the rear face of tool body 15 by a pin 140 (e.g., a 4-40×3/8 BH screw sold by McMaster Carr), and is moveable between an “inactive” position (the “up” position in the frame of reference of FIGS. 3-5) in which safety stop 130 prevents push button 125 from pressing against rear end 110 of pepper spray unit 25, and an “active” position (the “down” position in the frame of reference of FIGS. 3-5) in which push button 125 may be pressed against rear end 110 of pepper spray unit 25. Thus, in its “inactive” position, safety stop 130 holds push button 125 so that push button 125 is not able to press against rear end 110 of pepper spray unit 25. Therefore, if the user were to depress push button 125 while safety stop 130 is in its “inactive” position, push button 125 would not engage rear end 110 of pepper spray unit 25 and no pepper spray fluid would be discharged. In order to dispense pepper spray fluid, the user must first move safety stop 130 into its “active” position wherein push button 125 is able to press against rear end 110 of pepper spray unit 25. This is done by moving safety stop 130 downward along vertical slot 135. After moving safety stop 130 down into the “active” position, the user is able to spray pepper spray fluid by depressing rear end 110 of pepper spray unit 25 via push button 125.

With respect to flashlight 30, flashlight 30 comprises a cylindrical flashlight (e.g., a Redline tactical flashlight sold by NEBO, or another flashlight available from NEBO or another manufacturer) having a front end 145 from which light is emitted and a rear end 150 by which operation of flashlight 30 is controlled (e.g., turning the flashlight on/off, dimming, changing flash patterns, etc. by pushing on a button provided on rear end 150). Flashlight 30 is loaded, rear end 150 first, into the front end of cavity 100 until flashlight 30 is flush, or near flush, to the rear face of tool body 15. Flashlight 30 is then secured within cavity 100 of tool body 15 by two set screws 155 (e.g., two 1/4-20×¼ cup point set screws sold by McMaster Carr) which are advanced through the top of tool body 15 and which pinch down on flashlight 30 so as to secure flashlight against movement relative to tool body 15.

In use, when multi-purpose illumination, self-defense and glass-breaking tool 5 is to be used, it is first held by one hand of a user, with the fingers of the user extending into interior space 50 of handle 10. Then, if multi-purpose illumination, self-defense and glass-breaking tool 5 is to be used to break glass (e.g., a car window in the case of an emergency), glass breaker 20 of multi-purpose illumination, self-defense and glass-breaking tool 5 is driven against the glass. Or if multi-purpose illumination, self-defense and glass-breaking tool 5 is to be used for personal defense, safety stop 130 is slid from its “inactive” position down to its “active” position, and then rear end 110 of pepper spray unit 25 is depressed via push button 125 so as to discharge pepper spray fluid from the front end 105 of pepper spray unit 25. Or if multi-purpose illumination, self-defense and glass-breaking tool 5 is to be used for illumination, rear end 150 of flashlight 30 is used to turn the flashlight on so that light is emitted from front end 145 of flashlight 30.

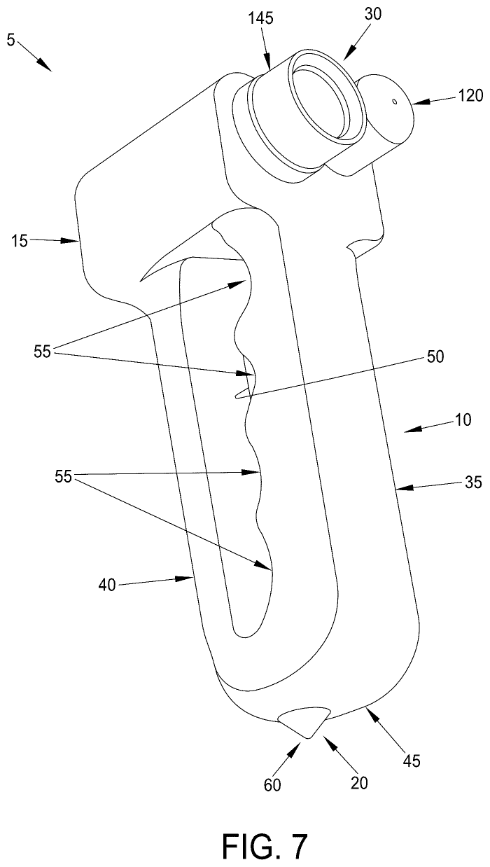

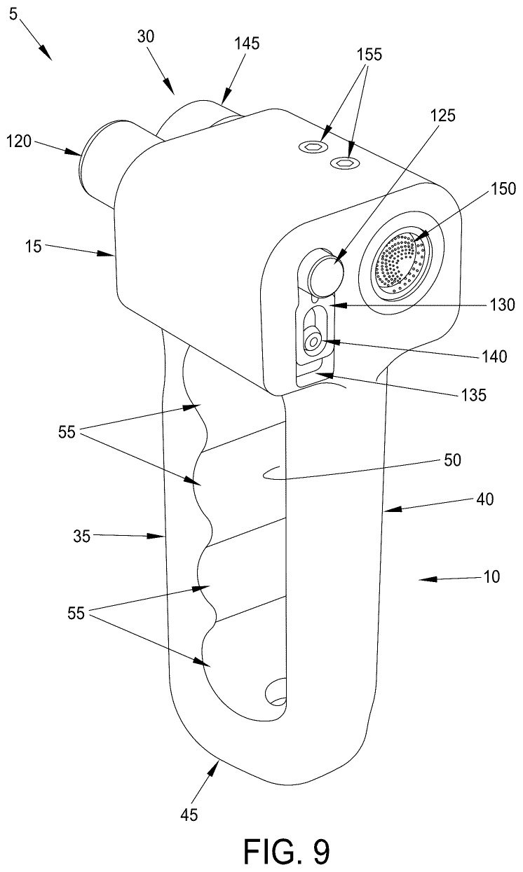

In an alternative embodiment of the invention, and looking now at FIGS. 6-10, latch 70 may be omitted, i.e., rear leg 40 of handle 10 may be a single piece of material. In this case, handle 10 and tool body 15 may be formed integral with one another.

### Multi-Purpose Survival Tool

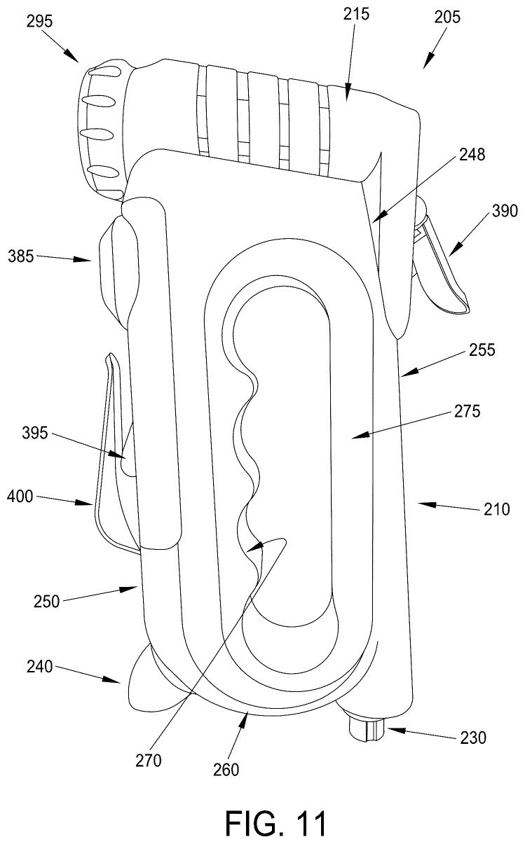

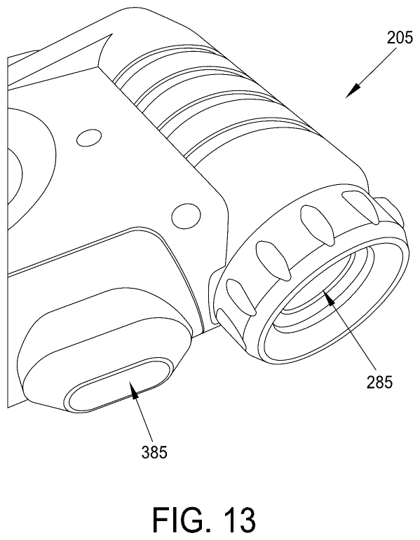

In another embodiment of the invention, and looking now at FIGS. 11-14, there is shown a multi-purpose survival tool 205. Tool 205 is generally similar to multi-purpose illumination, self-defense and glass-breaking tool 5 discussed above, however, tool 205 disposes its flashlight and pepper spray unit in a different manner than tool 5 and includes, among other features, a novel deployment mechanism for actuating the pepper spray unit, as will hereinafter be discussed in further detail.

More particularly, tool 205 generally comprises a handle 210 extending from a tool body 215, wherein (i) handle 210 comprises a pepper spray unit 220, an actuation element 225 for actuating pepper spray unit 220, a glass-breaking tool 230, a shielded blade 235 for cutting a seat belt and a threat pacification device 240, and (ii) tool body 215 comprises a flashlight 245.

More particularly, handle 210 is formed so as to comprise a generally “U”-shaped” hand-receiving cavity which projects from the bottom of tool body 215. In a preferred form of the present invention, the hand-receiving cavity of handle 210 is formed by a top connector 248 disposed adjacent to, and extending parallel to, tool body 215, a front leg 250 and a rear leg 255, both of which project downward from, and extend perpendicular to, the bottom of tool body 215 (i.e., from top connector 248), and a bottom connector 260 which extends between the bottom portions of front leg 250 and rear leg 255 (and parallel to tool body 215 and top connector 248). Tool body 215 and the shape of handle 210 in turn create a central opening 265 which is sized to receive the four fingers of a user's hand.

Alternatively, if desired top connector 248 can be omitted and front leg 250 and rear leg 255 can extend directly from tool body 215, with tool body 215, front leg 250, rear leg 255 and bottom connector 260 forming central opening 265.

In one form of the invention, central opening 265 is sized to snugly receive the four fingers of a user's hand, with the heel of the hand resting against rear leg 255. In order to improve the fit and prevent slippage of the user's fingers within central opening 265, a contoured knuckle rest 270 may be provided on the inward-facing surface of front leg 250 in order to closely contour-mate front leg 250 with the four fingers of the user's hand. To further improve the fit, and as will be discussed in further detail below, contoured knuckle rest 270 may be provided as a removable grip insert 275 for insertion in central opening 265 so as to properly hold hands of various sizes within central opening 265.

Significantly, with such a construction, multi-purpose survival tool 205 can be maintained on the user's hand solely by the fit of handle 210 around the user's fingers (i.e., the user does not need to actively grip rear leg 255 of handle 210 with the four fingers of his/her hand). It will be appreciated that, without the need for the user to actively grip rear leg 255 of handle 210 with the four fingers of his/her hand, the four fingers of the user's hand are free to grab keys, open a door, hold a firearm, etc., while the user simultaneously wields survival tool 205.

Looking now at FIGS. 11-16, tool body 215 comprises a flashlight cavity 280 for receiving flashlight 245. Flashlight cavity 280 (and therefore flashlight 245) extend horizontally through tool body 215 from the front end of tool body 215 to the rear end of tool body 215. With flashlight 245 in this orientation, the user is able to easily reach/operate the back end of flashlight 245 with the user's thumb of the same hand holding multi-purpose survival tool 205.

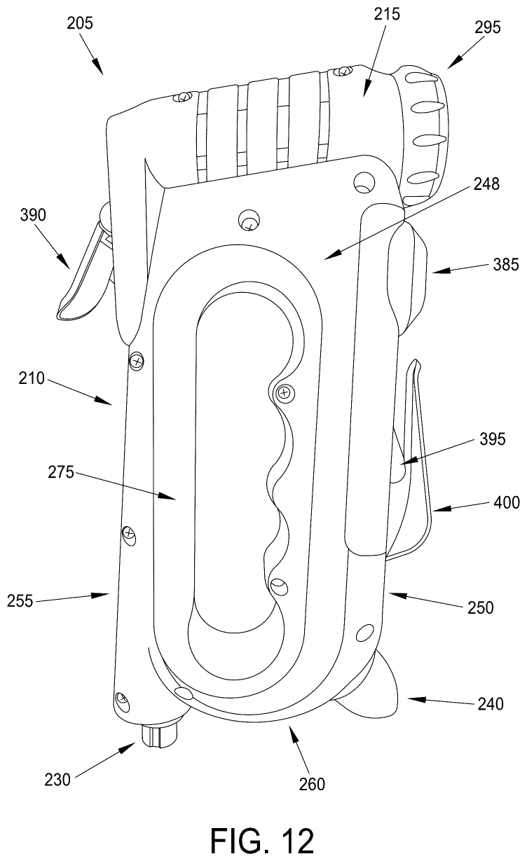

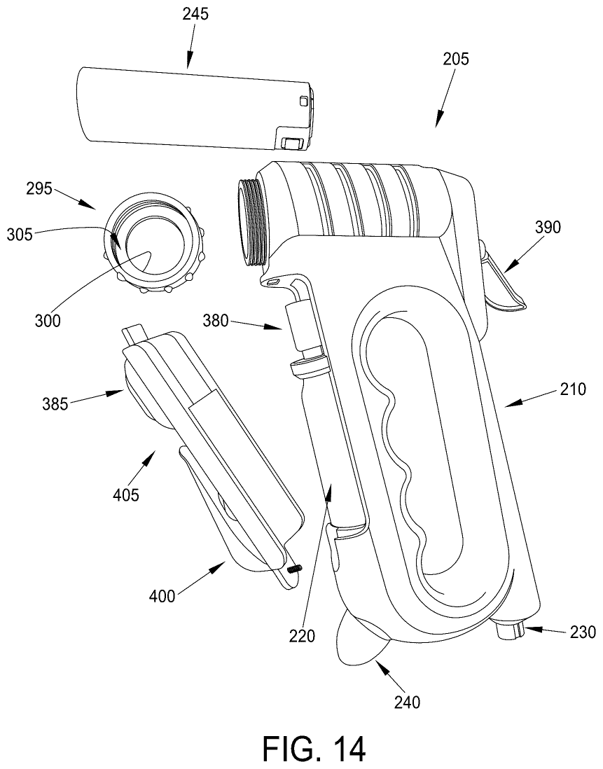

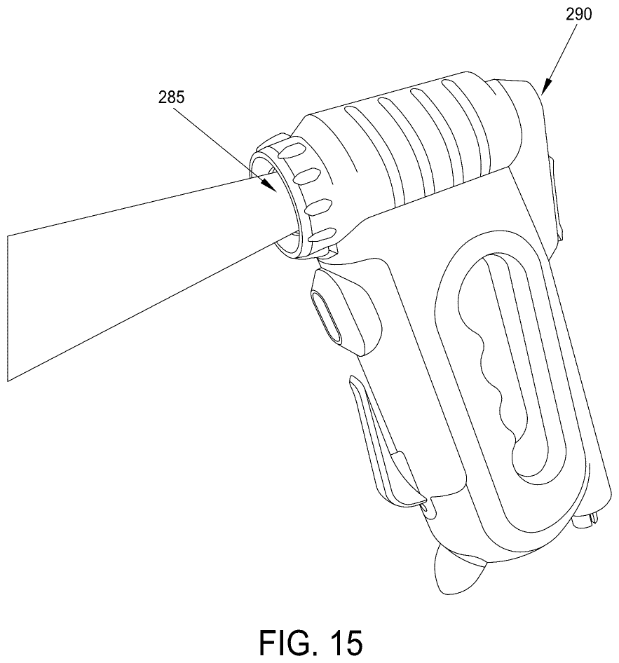

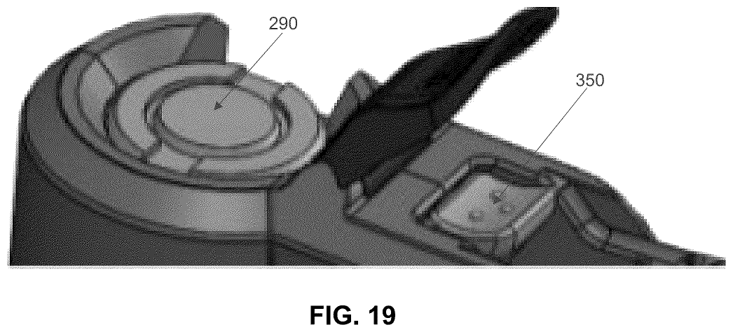

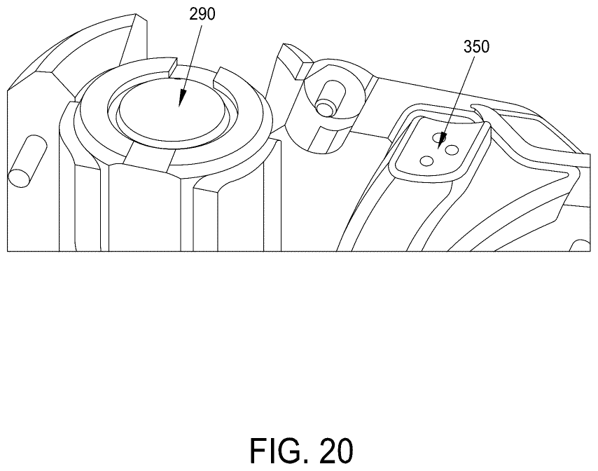

Flashlight 245 preferably comprises an internal power source (e.g., a battery, not shown) for powering a light-emitting element 285 (e.g., one or more LEDs) disposed at a forward end of flashlight 245, and an actuation element 290 (e.g., a push button) disposed at the rear end of flashlight 245 for operating light-emitting element 285 (e.g., turning the light on/off, dimming the light, changing flash patterns of the light, etc.). Both light-emitting element 285 and actuation element 290 are exposed (e.g., by openings formed on either end of flashlight cavity 280) such that light emitted by light emitting element 285 can be projected away from tool 205, and such that a user can easily access actuation element 290 using the user's thumb. In a preferred embodiment of the invention, flashlight 245 is loaded into flashlight cavity 280 until light emitting element 285 of flashlight 245 is flush, or near flush, to the front face of tool body 215. Flashlight 245 is then secured within flashlight cavity 280 via a screw cap 295 (FIG. 12) that threadingly engages the front end of tool body 215 around a perimeter of flashlight cavity 280. Screw cap 295 comprises a central opening 300 (FIG. 14) having a diameter smaller than the diameter of flashlight 245 (and cavity 280) so as to present a circumferential lip 305 (FIG. 14) that abuts flashlight 245 and holds it within flashlight cavity 280 when screw cap 295 is mounted to tool body 215. Furthermore, if desired, flashlight 245 comprises a charging port 310 (FIG. 33) (e.g., a USB-C port, etc.) for permitting the attachment of a charging cord to flashlight 245 so as to charge the battery of flashlight 245, as will be apparent to one of skill in the art in view of the present disclosure. Alternatively, it should be appreciated that, if desired, flashlight 245 may be permanently enclosed within flashlight cavity 280, e.g., formed integral with flashlight cavity 280 or sealed within flashlight cavity 280 so as to be inaccessible to a user. In this form of the invention, screw cap 295 may be omitted and replaced with a permanent cap that is formed integral with the remainder of tool body 215, as will be apparent to one of skill in the art in view of the present disclosure.

Looking now at FIGS. 14, 17 and 18, handle 210 comprises a pepper spray unit cavity 315 sized to receive disposable pepper spray unit 220, and actuation element 225 for selectively actuating pepper spray unit 220 as will hereinafter be discussed in further detail.

Pepper spray unit cavity 315 comprises a first portion 320 for receiving pepper spray unit 220 and a second portion 325 for receiving actuation element 225 for actuating pepper spray unit 220. First portion 320 (and therefore pepper spray unit 220) extend vertically through front leg 250 of handle 210 and second portion 325 (and therefore actuation element 225) extend horizontally through handle 210 from the pepper spray unit 220 to a finger-activating lever 330 disposed at rear leg 255 of handle 210. With pepper spray unit 220 and actuation element 225 in this orientation, the user is able to easily reach/operate actuation element 225 with the thumb of the user's same hand holding multi-purpose survival tool 205.

Furthermore, by orienting pepper spray unit 220 vertically through handle 210, pressurized gas is able to act as an efficient accelerant for emitting the liquid contained (i.e., a “pepper spray” irritant) within pepper spray unit 220. To this end, it has been found that liquid-based pepper sprays driven by a compressed gas are more efficiently released from a pepper spray unit 220 when the pepper spray unit is disposed in a vertical orientation. More particularly, the liquid within a pepper spray unit is concentrated near the lower portion of a pepper spray unit (i.e., by the force of Earth gravity) and pressurized gas acts as an accelerant for emitting the liquid contained within the pepper spray unit. If the pepper spray unit is disposed in a horizontal orientation, the pressurized gas is not able to cause the liquid within the horizontally-disposed pepper spray unit to be released from the pepper spray unit. However, as a result of the vertical disposition of pepper spray unit 220 in tool body 205, the pressurized gas is able to act as an accelerant for emitting the liquid contained within pepper spray unit 220.

In one preferred form of the present invention, and looking now at FIGS. 17 and 18, actuation element 225 comprises the aforementioned finger actuating lever 330 configured to selectively pivot about a pivot point 335 (e.g., a pin) and a spray actuation lever 340 configured to pivot around a pivot point 345 (e.g., a pin). More particularly, finger actuating lever 330 comprises a first end 350 for engagement with the thumb of a user and a second end 355 comprising a plurality of radially extending teeth 360. Spray actuation lever 340 comprises a first end 365 comprising a plurality of radially-extending teeth 370 for mating with the plurality of radially extending teeth 360 of finger actuating lever 330 and a second end 375 configured to selectively actuate pepper spray unit 220, e.g., by selectively moving downward relative to pepper spray unit 220 so as to engage a push button of pepper spray unit 220 and release the contents of pepper spray unit 220. As a result of this construction, when first end 350 of finger actuating lever 330 is moved down, the plurality of radially extending teeth 360 at second end 355 of finger actuating lever 330 pivot around pivot point 335, which in turn causes the plurality of radially-extending teeth 370 formed on first end 365 of spray actuation lever 340 to pivot around pivot point 345 in the manner of a gear, which in turn, causes second end 375 of spray actuation lever 340 to move downward relative to pepper spray unit 220 so as to engage a push button and release the contents of pepper spray unit 220. To that end, pepper spray unit 220 comprises an emitter 380 (e.g., a spray nozzle) aligned with an emission port 385 formed in front leg 250 of handle 210.

Thus, as a result of the foregoing construction, downward movement of finger actuation lever 330 (e.g., movement of the thumb downward, which might be considered to be a natural movement to actuate an element) effects clockwise rotation of finger actuation lever 330 about pivot point 335 which, in turn, effects counterclockwise rotation of spray actuation lever 340 about pivot point 345, which, in turn, causes the contents of pepper spray unit 220 to be emitted out of emitter 380 of pepper spray unit 220 via emission port 385.

If desired, a safety cover 390 (FIGS. 11 and 12) may be disposed over first end 350 of finger actuation lever 330 in order to prevent actuation element 225 from inadvertently activating pepper spray unit 220.

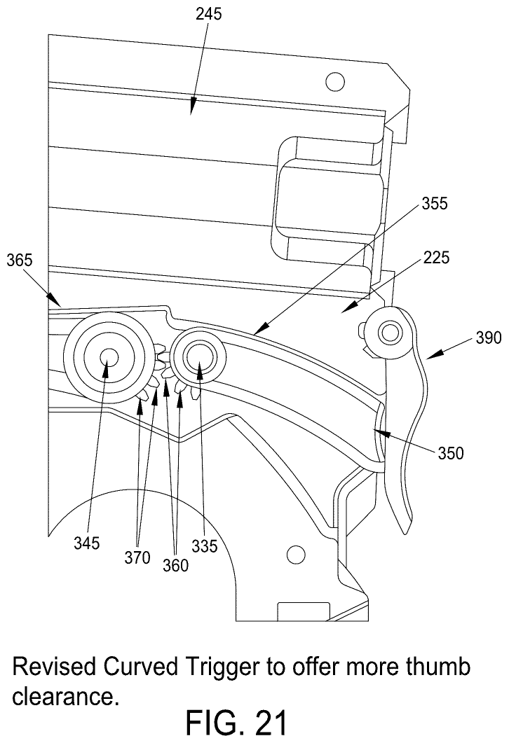

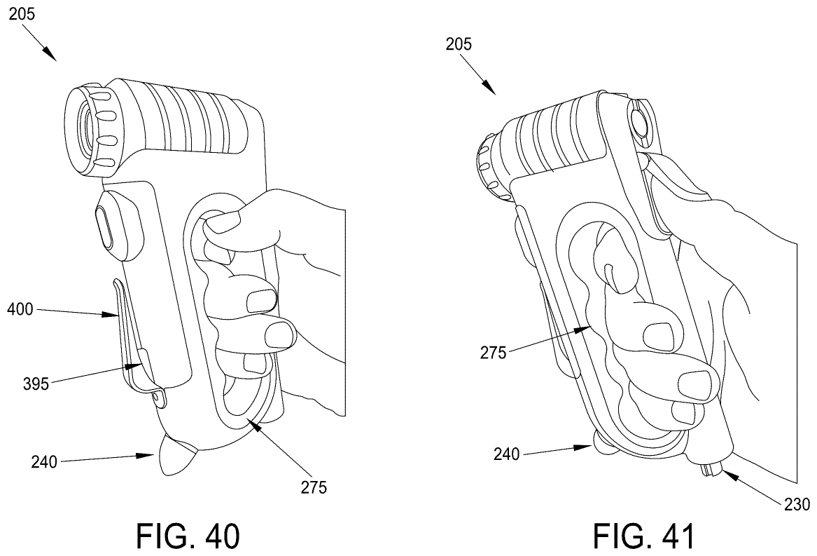

Furthermore, if desired, a curved trigger may be provided at first end 350 of finger actuation lever 330 in order to offer more thumb clearance (FIG. 21).

In alternative embodiment of the present invention, and looking now at FIGS. 22-24, if desired, actuation element 225A may comprise a single pivoting element that pivots around a single pivot point 335A (e.g., a pin). In this form of the present invention, actuation element 225A comprises a first end 320A for engagement by a finger of the user and a second end 325A for depressing a button on pepper spray unit 220. With this form of the invention, pepper spray unit 220 may be activated by the user moving first end 320A of actuation element 225A upward from a first position to a second position, which causes second end 325A of actuation element 225A to depress a button on pepper spray unit 220 to release the contents of pepper spray unit 220.

Importantly, with tool 205, flashlight 245 is disposed such that the longitudinal axis of the long dimension of flashlight 245 is disposed substantially parallel to the longitudinal axis of the long dimension of tool body 215 and pepper spray unit 220 is disposed such that the longitudinal axis of the long dimension of pepper spray unit 220 is disposed parallel to the longitudinal axis of the long dimension of handle 210 (i.e., substantially perpendicular to flashlight 245). Thus, when a user grips handle 210 and raises tool 205 to aim pepper spray unit 220 at an assailant, flashlight 245 is disposed generally parallel to the plane of the ground upon which the user stands (i.e., horizontally oriented or generally perpendicular to the force of Earth gravity) and pepper spray unit 220 is disposed generally perpendicular to the plane of the ground upon which the user stands (i.e., vertically oriented or generally parallel to the force of Earth gravity).

If desired, and looking now at FIGS. 25 and 26, tool 205 may further comprise the aforementioned glass-breaking tool 230 for effecting the breaking of glass (e.g., the window of a vehicle) as may be necessary during an emergency situation (e.g., to escape from a vehicle sinking in water, to remove a person trapped in a vehicle, etc.). Glass-breaking tool 230 is preferably disposed on bottom connector 260 of handle 210 such that, when the user grips handle 210 with their thumb in the region of finger actuating lever 330, glass-breaking tool 230 is situated near the heel of the hand. Glass-breaking tool 230 preferably comprises a spring-loaded pointed metal element that extends outboard when a sufficient force is applied to glass-breaking tool 230, whereby to extend a sharp metal tip under the power of a spring. Thus, when glass-breaking tool 230 is pressed against a glass surface with sufficient force, the tool is activated and the sharp metal tip extends (e.g., under the power of a compressed spring) so as to break the glass.

It should also be appreciated that, if desired, tool 205 may further comprise a shielded blade for cutting an object (e.g., a seat belt) during an emergency situation (e.g., to escape from a vehicle, to remove a person from a vehicle, etc.). To that end, and looking now at FIGS. 27-32, if desired, front leg 250 of handle 210 of tool 205 may further comprise a shielded blade 395 disposed in a blade housing 400 extending outboard from handle 210. In a preferred embodiment of the invention, blade housing 400 and shielded blade 395 extend outboard from a removable cover 405 mounted to front leg 250 of handle 210 (FIG. 14), thereby disposing shielded blade 395 in the “front” area of tool 205 where a user may easily use shielded blade 395 in an emergency situation to slash at an object (e.g., a seat belt) and cut the object. It will also be appreciated that removable cover 405 preferably serves to provide access to cavity 315 such that pepper spray unit 220 may be removed from, or replaced within, cavity 315, as will be apparent to one of skill in the art in view of the present disclosure. However, it should also be appreciated that, if desired, pepper spray cavity 315 may be sealed so as to be inaccessible to the user, i.e., pepper spray unit 220 may be sealed within cavity 315 during manufacture of tool 205 and hence inaccessible to the user. In this form of the invention, cover 405 may be permanently mounted to front leg 250 of handle 210 and/or formed integral therewith, as will be apparent to one of skill in the art in view of the present disclosure.

Shielded blade 395 and/or blade housing 400 may comprise various configurations of blades and housings. By way of example but not limitation, FIGS. 27-32 show some exemplary configurations for shielded blade 395 and/or blade housing 400 formed in accordance with the present invention. Other configurations for shielded blade 395 and/or blade housing 400 will be apparent to one of skill in the art in view of the present disclosure and fall within the scope of the present invention.

It should also be appreciated that, if desired, tool 205 may further comprise a threat pacification tool for use in effecting self-defense. More particularly, and looking now at FIGS. 11 and 12, there is shown the aforementioned threat pacification device 240 mounted to bottom connector 260 of handle 210. Threat pacification device 240 preferably comprises a plastic (or metal) element having a tip that can be used to apply pressure to a pressure point, whereby to neutralize a threat. By way of example but not limitation, a user may swing tool 205 downwards onto an area of the body of an attacker, whereby to apply painful pressure to the attacker via threat pacification device 240 (and thereby provide the user with the opportunity to escape the attacker). If desired, threat pacification device 240 may be mounted to handle 210 via a screw thread connection (not shown), as will be apparent to one of skill in the art in view of the present disclosure.

As discussed above, handle 210 is configured such that it defines central opening 265 which receives grip insert 275. As a result of this construction, it should be appreciated that tool 205 may be modified so as to include a grip insert 275 appropriate to the hand-size of the user. By way of example but not limitation, and looking now at FIGS. 33-36, grip insert 275 may be provided in the form of a “small” grip insert 275A (e.g., for receiving the hand of a user with small hands) (FIG. 34), a “medium” grip insert 275B (e.g., for receiving the hand of a user with average-sized hands) (FIG. 35), or a “large” grip insert 275C (e.g., for receiving the hand of a user with large hands) (FIG. 36). Grip insert 275 (or 275A, 275B, 275C, etc.) is preferably mounted within central opening 265 via a press-fit, however, it should be appreciated that grip insert 275 may alternatively be mounted within central grip opening 265 (i.e., to handle 210) via one or more fasteners (not shown), as will be apparent to one of skill in the art in view of the present disclosure.

And it should also be appreciated that, if desired, tool 205 may be provided with a lanyard for securing tool 205 to a person or object. To that end, and looking now at FIG. 37, if desired, handle 210 may comprise a lanyard anchor 410 configured to receive a lanyard 415.

In one form of the invention, a latch 420 may be provided on rear leg 255 of handle 210 so that handle 210 can act as a carabiner for clipping or hanging tool 205 to another object (e.g., to a belt or to a loop provided on an article of clothing), or for clipping or hanging another object (e.g., a whistle on a short lanyard) to tool 205. More specifically, rear leg 255 of handle 210 may comprise a bottom section 425 and a top section 430, with an arm 435 extending therebetween. One end of arm 435 is pivotally mounted to bottom section 425 of rear leg 255 by a spring pin (not shown) such that arm 435 is able to swing outward from top section 430, opening the “U” shape of handle 210 so that central opening 265 of the handle can be accessed through latch 420 of rear leg 255, and then spring back into contact with top section 430 so as to restore the “U” shape of handle 210 (i.e., so that central opening 265 of the handle can no longer be accessed through latch 420 of rear leg 255). To help keep the “U” shape of handle 210 closed, a selective closure means (e.g., a magnet) may be provided on top section 430 of rear leg 255 and the free end of arm 435.

In use, when tool 205 is to be used, it is first held by one hand of a user, with the fingers of the user extending into central opening 265 of handle 210. Then, if tool 205 is to be used to break glass (e.g., a car window in the case of an emergency), glass breaking tool 230 of tool 205 is driven against the glass. Or if tool 205 is to be used for personal defense, safety cover 390 is lifted from its “down” position to its “up” position, and then first end 350 of finger activating lever 330 of actuation element 225 is pressed so as to discharge pepper spray fluid from emitter 380 of pepper spray unit 220. Or, if tool 205 is to be used for illumination, actuation element 290 of flashlight 245 is used to turn the flashlight on so that light is emitted from the front end of flashlight 245.

### Modifications Of The Preferred Embodiments

It should be understood that many additional changes in the details, materials, steps and arrangements of parts, which have been herein described and illustrated in order to explain the nature of the present invention, may be made by those skilled in the art while still remaining within the principles and scope of the invention.

What is claimed is:

1. A multi-purpose tool, the tool comprising:
a front leg having an upper portion and a lower portion;
a rear leg having an upper portion and a lower portion;
a top portion connecting the upper portion of the front leg to the upper portion of the rear leg; and
a bottom portion connecting the lower portion of the front leg to the lower portion of the rear leg;
an illumination unit disposed in the top portion of the tool; and
a pepper spray unit disposed in the front leg of the tool;
wherein the front leg, the rear leg, the top portion and the bottom portion form a central cavity that is sized to receive fingers of a user's hand, with the heel of the hand resting against the rear leg and the thumb of the hand free to manipulate (i) an illumination actuation element for operating the illumination unit, and (ii) a pepper spray actuation element for operating the pepper spray unit.

2. The multi-purpose tool of claim 1 wherein the illumination unit comprises a light-emitting element for emitting light along a light emission axis, wherein the light emission axis is transverse to a longitudinal axis of the front leg.

3. The multi-purpose tool of claim 1 wherein the pepper spray unit comprises a pepper spray canister and a pepper spray dispenser configured to emit pepper spray from the pepper spray canister along a pepper spray axis, wherein the pepper spray canister is disposed along a longitudinal axis that is parallel to a longitudinal axis of the front leg and the pepper spray axis is transverse to the longitudinal axis of the front leg.

4. The multi-purpose tool of claim 3 wherein the front leg comprises a pepper spray emission port.

5. The multi-purpose tool of claim 1 wherein the pepper spray actuation element comprises a finger actuating lever comprising a first end and a second end, wherein movement of the first end of the finger actuating lever in a first direction causes the second end of the finger actuating lever to depress a pepper spray release button on the pepper spray unit.

6. The multi-purpose tool of claim 1 wherein the pepper spray actuation element comprises a finger actuating lever comprising a first end and a second end and a spray actuating lever comprising a first end and a second end, wherein movement of the first end of the finger actuating lever in a first direction causes the second end of the finger actuating lever to move the spray actuating member to depress a pepper spray release button on the pepper spray unit.

7. The multi-purpose tool of claim 6 wherein the second end of the finger actuating lever is rotatably mounted to the tool and the first end of the spray actuating lever is rotatably mounted to the tool.

8. The multi-purpose tool of claim 7 wherein the second end of the finger actuating lever comprises a plurality of teeth, wherein the first end of the spray actuating lever comprises a plurality of teeth, and further wherein rotation of the plurality of teeth of the finger actuating lever rotates the plurality of teeth of the spray actuating lever.

9. The multi-purpose tool of claim 1 further comprising a safety cover for selectively preventing actuation of the pepper spray unit.

10. The multi-purpose tool of claim 9 wherein the safety cover is pivotally mounted to the rear leg of the tool, and further wherein the safety cover is movable between (i) an “inactive” position in which the safety cover prevents the pepper spray actuation element from actuating the pepper spray unit, and (ii) an “active” position in which the safety cover exposes the pepper spray actuation element such that the pepper spray actuation element may be moved to actuate the pepper spray unit.

11. The multi-purpose tool of claim 1 wherein the front leg comprises a removable cover for accessing the pepper spray unit.

12. The multi-purpose tool of claim 1 wherein the rear leg comprises a fixed portion and a pivotable portion such that the pivotable portion of the rear leg is pivotable between an open cavity position and a closed cavity position.

13. The multi-purpose tool of claim 12 wherein the pivotable portion of the rear leg is spring-biased to the closed cavity position.

14. The multi-purpose tool of claim 12 wherein one of the fixed portion and the pivotable portion comprises a magnet to help keep the rear leg in the closed cavity position.

15. The multi-purpose tool of claim 1 wherein the tool further comprises a glass breaker.

16. The multi-purpose tool of claim 15 wherein the glass breaker is disposed on at least one of the rear leg of the tool and the bottom portion of the tool.

17. The multi-purpose tool of claim 15 wherein the glass breaker comprises a spring-loaded pointed metal element that extends outboard when a pre-determined force is applied to the glass breaker, whereby to extend a sharp metal tip under the power of a spring.

18. The multi-purpose tool of claim 1 wherein the illumination unit is held within the upper portion of the tool by at least one selected from the group consisting of at least one set screw and a removable screw cap.

19. The multi-purpose tool of claim 1 further comprising a power source for illuminating the illumination unit.

20. The multi-purpose tool of claim 19 wherein the power source comprises a battery.

21. The multi-purpose tool of claim 1 wherein a cavity-facing portion of the front leg comprises a contoured knuckle rest.

22. The multi-purpose tool of claim 21 wherein the contoured knuckle rest comprises a removable insert for disposition in the cavity of the tool.

23. The multi-purpose tool of claim 22 further comprising a kit of contoured knuckle rests having different sizes.

24. The multi-purpose tool of claim 22 wherein the removable knuckle rest is secured in the cavity using at least one of a press-fit and a screw.

25. The multi-purpose tool of claim 1 further comprising a threat pacification device.

26. The multi-purpose tool of claim 26 wherein the threat pacification device is disposed on at least one of the front leg and the bottom portion of the tool.

27. The multi-purpose tool of claim 1 further comprising a seat belt cutting tool.

28. The multi-purpose tool of claim 27 wherein the seat belt cutting tool is disposed on the front leg.

29. A method for providing at least one of illumination and pepper spray dispensing capability, the method comprising:
providing a multi-purpose tool, the tool comprising:
a front leg having an upper portion and a lower portion;
a rear leg having an upper portion and a lower portion;
a top portion connecting the upper portion of the front leg to the upper portion of the rear leg; and
a bottom portion connecting the lower portion of the front leg to the lower portion of the rear leg;
an illumination unit disposed in the top portion of the tool; and
a pepper spray unit disposed in the front leg of the tool;
wherein the front leg, the rear leg, the top portion and the bottom portion form a central cavity that is sized to receive fingers of a user's hand, with the heel of the hand resting against the rear leg and the thumb of the hand free to manipulate (i) an illumination actuation element for operating the illumination unit, and (ii) a pepper spray actuation element for operating the pepper spray unit;
passing fingers of a hand of a user through the cavity of the tool; and
using the thumb of the hand of the user to perform at least one of the following actions:
(i) providing illumination via the illumination unit; and
(ii) dispensing pepper spray from the pepper spray unit.
